(19) United States
(12) Patent Application Publication
(10) Pub. No.: US 2023/0385813 A1
(43) Pub. Date: Nov. 30, 2023

(54) SYSTEM FOR RECURRING TIME-BASED BOUND TOKENS

(71) Applicant: Capital One Services, LLC, McLean, VA (US)

(72) Inventors: Allison FENICHEL, Brooklyn, NY (US); Varun GUPTA, Brooklyn, NY (US); Amanda SNEIDER, New York, NY (US)

(73) Assignee: Capital One Services, LLC, McLean, VA (US)

(21) Appl. No.: 17/752,163

(22) Filed: May 24, 2022

(51) Int. Cl. G06Q 20/38; G06Q 20/34

(52) U.S. Cl. CPC G06Q 20/3821; G06Q 20/351

(57) ABSTRACT

A method, system and computer program product for generating and managing a time-bound virtual payment card are disclosed. A primary account holder requests a virtual payment card linked to their account to share spending with a third party while maintaining the security of their account. In the request, the account holder specifies a recipient and conditions for use of the virtual payment card including recurring temporal parameters. A service managed by the card issuing financial institution receives the request and generates a virtual card configured to the parameters specified. Thereafter, the service sends the virtual card to the specified recipient. After activating the virtual payment card, the recipient attempts a purchase at a merchant. Upon checkout, the service receives a request from the merchant and based on the transaction information in the request, determines whether the transaction meets the conditions for use and approves or denies the transaction accordingly.

### BACKGROUND

The use of payment cards (e.g., credit card, debit card) has become the preferred mode of performing financial transactions both online and at point of sale terminals of merchants. Moreover, as more and more consumers have begun to exclusively use payment cards for a majority of their day-to-day transactions, payment cards have become easier and safer to use. However, sharing payment card information with others and ensuring that it is used for the intended purposes at the intended times is still a pain point for consumers.

### SUMMARY

Whether in a business or family setting, there is often a need to share payment card information for specific purchases. For example, a parent might want to enable their child to use a payment card to purchase lunch on specific days of the week. The parent wants to be able to ensure that the child is only able to use the payment card on those days to purchase lunch and prevent the child from making frivolous purchases. The parent could make the child an authorized user on the account and have a physical or virtual card issued to the child. However, this does not allow the parent to have the level of control they would like on the transactions that can be made using the card. Moreover, some card issuers issue authorized users cards with the same card number as the primary account holder, which can be a security concern. This is particularly the case with a physical that a child can easily lose. Accordingly, what is needed is a solution that allows the primary account holder to issue a virtual payment card with specific temporal and transaction restrictions to a family member or acquaintance. A virtual payment card solution provides extra security on the card while also allowing the primary account holder to share spending with others without worry that they will create unnecessary expenses beyond what the primary account holder intends. This virtual payment card is referred to herein as a virtual card number (VCN).

### BRIEF DESCRIPTION OF THE DRAWINGS

The accompanying drawings are incorporated herein and form a part of the specification.

FIG. 1 illustrates a block diagram of a system for generating and managing a time-bound VCN, in accordance with some embodiments.

FIGS. 2-4 illustrate example user interfaces of a mobile banking application installed on an account holder device illustrated in FIG. 1 for reviewing and managing one or more time-bound VCNs, in accordance with some embodiments.

FIG. 5 illustrates a flowchart for an example method of generating and managing the use of a time-bound VCN, in accordance with some embodiments.

FIG. 6 illustrates an example computer system in accordance with some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for generating and managing a time-bound VCN. The VCN is created by a primary account holder and linked to the primary account. A new card number is generated when issuing a VCN such that each VCN is unique and different from a primary account card number. Temporal restrictions for a VCN may include recurring time periods when the VCN can be used to make purchases. Other restrictions may also be specified such as specific merchants and/or geolocations where the VCN may be used and categories of purchases for which the VCN may be used. Additionally, a spending limit may be specified for the VCN. These restrictions may be specified when creating the VCN or after the VCN has been generated and issued to the designated user.

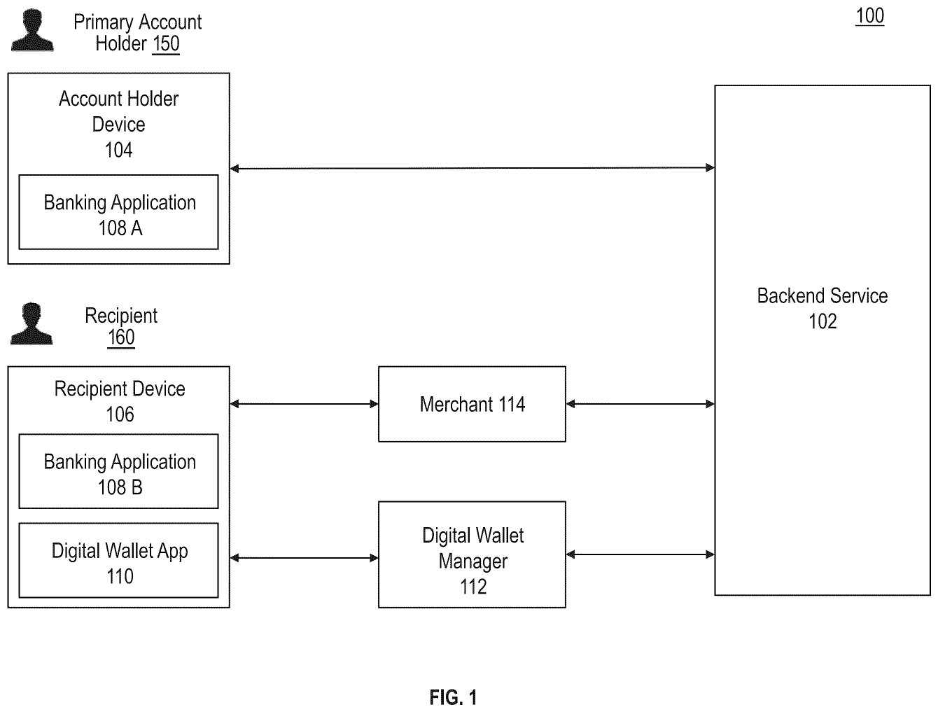

FIG. 1 illustrates a block diagram of a system 100 for generating and managing a time-bound VCN, according to some example embodiments. As shown in FIG. 1, the system 100 includes a backend service 102. In some embodiments, the backend service 102 may be managed by a payment card issuer financial institution and comprise one or more computing devices (e.g., servers, mainframes, etc.) connected by a network with wired and/or segments.

In some embodiments, the system 100 may also include user devices 104 and 106 examples of which may include a desktop PC, tablet, laptop, smart phone, etc. A user who has an account (e.g., checking account, credit card, etc.) with a financial institution managing backend service 102 may access their account through banking application 108. Banking application 108 may be a mobile application or a web application that may be accessed using a web browser.

In some embodiments, backend service 102 is configured to require authentication of a user in order to login to their account via banking application 108. The user may be authenticated using user credentials (e.g., username and password) and/or biometric information. Biometric information may include fingerprints, the shape of the hand and/or the finger, the shape of the face, iris or retina of the eye, etc. The user may also be authenticated using multifactor authentication for additional security.

The user may be primary account holder 150 using account holder device 104 to access banking application 108A and login to their account. In some embodiments, primary account holder 150 may have a credit card with a financial institution managing backend service 102. As such, once successful login has been achieved, banking application 108A may display information regarding the credit card account of primary account holder 150. For example, banking application 108A may allow primary account holder 150 to view a current balance, spending activity, credit limit, etc. associated with the credit card. Additionally, banking application 108A may provide functionality for managing the credit card. For example, primary account holder 150 may be able to use banking application 108A to freeze a lost or stolen card to avoid fraudulent charges. Primary account holder 150 may also be able to use banking application 108A to pay off the balance on the credit card, increase the credit line, order a replacement card, add an authorized user, etc.

Under certain circumstances, a primary account holder may want to share payment card information for use by a third party. For example, primary account holder 150 may be a parent who wants to allow their child to use their credit card to buy lunch on school days. Alternatively, primary account holder 150 may be a small business owner who wants to give an employee the ability to use the business credit card to buy supplies for jobs while working for a client on-site.

In these circumstances, there is a need for primary account holder 150 to retain a high level of control over the use of the payment card. Furthermore, it is important that access to the payment card is shared in a manner that keeps the card information secure. As such, sharing a virtual card (VCN) with a different card number is preferred. In some embodiments, banking application 108A may provide functionality to primary account holder 150 for requesting a VCN for a third party.

In some embodiments, banking application 108A may prompt primary account holder 150 to provide identification information (e.g., name, phone number, email address, home address, date of birth, etc.) about the desired recipient of the new VCN. The recipient information provided by primary account holder 150 may identify recipient 160 (e.g., a child of primary account holder 150) as the desired recipient. Banking application 108A may further prompt primary account holder 150 to specify various conditions for use of the VCN. These conditions may include temporal parameters, geolocation restrictions, merchant restrictions, purchase category restrictions, etc. describing when, where, and how the VCN can be used by recipient 160.

For example, primary account holder 150 may want to create a VCN for recipient 160 to purchase school supplies during the first three weeks of the school year. Accordingly, primary account holder 150 may choose a start and end date during which the VCN will be active and set no recurrence pattern, such that after the specified end data, the VCN will no longer be active and recipient 160 will not be able to complete any transactions using this VCN. Alternatively, primary account holder 150 may choose a yearly recurrence pattern. In some embodiments, upon selecting a yearly recurrence pattern, banking application 108A may provide an option to select one or more months of the year when the VCN will be active for the three-week period specified by the initial start and end dates. For example, the initial active period specified may be September 1^{st}-21^{st} and primary account holder 150 may want the VCN to be active at the beginning of every semester instead of just in September of each year. Accordingly, primary account holder 150 may select the months of September and January. With these selections, the VCN will be active September 1^{st}-21^{st} and January 1^{st}-21^{st} of each year. Additionally, primary account holder 150 may determine when the recurrence pattern will end. Banking application 108A may provide options to end the recurrence pattern after a number of occurrences or on a specific date. Banking application 108A may also provide a “no end date” option allowing the recurrence pattern to continue indefinitely until primary account holder 150 updates the VCN parameters. If the recurrence pattern is configured to terminate, once the end date or number of occurrences has been reached, the VCN may become inactive. In some embodiments, primary account holder 150 may be able to update the temporal parameters for the VCN after the recurrence end date has passed, causing the VCN to become active once again. Alternatively, the VCN may be permanently deactivated after the recurrence end date.

In addition to temporal parameters, primary account holder 150 may also specify a spending limit and list of approved purchase categories. For example, since the VCN is only intended for purchasing school supplies, primary account holder 150 may select several approved categories such as office supplies, electronics, school supplies, etc. Additionally, because some items in these categories may be very expensive, primary account holder 150 may set a single transaction spending limit in addition to the overall spending limit.

Once the various conditions for use of the VCN have been specified, banking application 108A may send a request containing the recipient information and VCN parameters provided by primary account holder 150 to backend service 102 to generate a new VCN. In response to the request, backend service 102 may verify the recipient information and generate a new VCN with a unique card number, linked to a primary account and configured to the parameters specified by primary account holder 150.

In some embodiments, backend service 102 may use the recipient information provided by primary account holder 150 to determine if recipient 160 has an existing account with the financial institution managing the backend service. This account may be a primary account owned by recipient 160 or an authorized user account created for use with another VCN. If recipient 160 has an existing account, backend service 102 may use the email address, phone number, etc. provided in the recipient information to match recipient 160 with an existing account. Backend service 102 may then generate and send a message informing recipient 160 a new VCN has been sent to them by primary account holder 150 and is ready to be activated. The message may also include the name of primary account holder 150, how to activate and use the VCN, and a link to a webpage for activating the VCN. Additionally or alternatively, backend service 102 may determine that recipient 160 has banking application 108B installed on their device 106 and send a push notification to recipient device 106. The notification may notify recipient 160 that they have received a new VCN and prompt them to activate the VCN. Selecting the notification may cause recipient device 106 to launch banking application 108B, which may automatically display a VCN activation screen. In some embodiments, banking application 108B may prompt recipient 160 to authenticate using account credentials (username and password), biometrics, or another authentication method before displaying the VCN activation screen.

Alternatively, backend service 102 may determine recipient 160 does not have an account with the financial institution and create an authorized user account for recipient 160 using the information provided by primary account holder 150. Backend service 102 may then generate and send a message to recipient 160 informing them a VCN has been sent to them by primary account holder 150. Additionally, the email may provide information regarding the new authorized user account created for recipient 160, activation and use of the VCN, and a link to a webpage for activating the authorized user account. Recipient 160 may use a web browser installed on recipient device 106 to open the link and access the webpage for activating their new account. The account activation webpage may prompt recipient 160 to provide identification information such as name, phone number, email address, date of birth, etc. Once recipient 160 has entered their information, the account activation webpage may generate and send a request to backend service 102 to verify the recipient's information and find the corresponding account. Upon receiving a response from backend service 102 containing account information for recipient 160, the account activation webpage may prompt recipient 160 to create a new password to complete the account activation process. In some embodiments, once recipient 160 has successfully activated their account, the account activation page may automatically redirect to a VCN activation page. Alternatively, the account activation page may redirect to a page prompting recipient 160 to download and install banking application 108B on recipient device 106.

In some embodiments, banking application 108B may automatically display a VCN activation screen when recipient 160 logs into their account. The VCN activation screen may include primary account holder 150 and last four digits of the card number of the VCN being activated. Recipient 160 may activate the VCN by selecting an activate button on the VCN activation screen. Once the VCN has been activated, banking application 108B may display, to recipient 160, a screen comprising details about the newly activated VCN. The details provided may include when, where and how the VCN may be used (e.g., temporal parameters, merchant restrictions, transaction category restrictions, etc.). For example, recipient 160 may be the student mentioned above and primary account holder 150 may have requested this VCN to allow recipient 160 to purchase school supplies. Accordingly, the VCN details screen may include at least the following:
dates when the VCN is active for use,
a recurrence pattern for the dates,
a list of approved purchase categories,
an overall spending limit, and
a single transaction spending limit.

In some embodiments, banking application 108B may prompt recipient 160 to add the VCN to a digital wallet 110 installed on recipient device 106. Digital wallet 110 may be a third-party digital wallet application such as Apple Pay, PayPal, Google Pay, Samsung Pay, etc. Recipient 160 may choose to add the VCN to digital wallet app 110 and select the appropriate button in banking application 108B to initiate enrollment of the VCN with digital wallet app 110. Accordingly, banking application 108B may communicate with digital wallet app 110 in the background and initiate an authentication process involving digital wallet manager 112 and backend service 102. In some embodiments, recipient 160 and recipient device 106 may have already been authenticated by backend service 102 during account login, thus allowing for a streamlined enrollment process. Once the authentication process has completed successfully, backend service 102 may authorize enrollment of the VCN with digital wallet app 110.

Alternatively, recipient 160 may decide to enroll the VCN at a later time. Recipient 160 may do this by logging into banking app 108B and selecting an option to add the VCN to digital wallet app 110. This option will result in a similar streamlined enrollment process as described above. In some embodiments, recipient 160 may choose to enroll the VCN directly through digital wallet app 110 and thus may be prompted to manually input the card number, expiration date, and security code associated with the VCN to initiate enrollment. Upon receiving the VCN information, digital wallet app 110 may send the VCN information, along with other user and device data for recipient 160 and recipient device 106, to digital wallet manager 112. Digital wallet manager 112 may then send a request to backend service 102 to authenticate the information from digital wallet app 110 and authorize enrollment of the VCN. Backend service 102 may use the information in the request to authenticate recipient 160, recipient device 106, and the digital wallet manager. After successful authentication, backend service 102 may authorize enrollment of the VCN with the digital wallet.

At this point, recipient 160 may decide to make a purchase at merchant 114 with the VCN. Merchant 114 may be a physical retail (e.g., local bookstore, Target, Staples, etc.) with a point-of-sale (POS) terminal that supports contactless payment or an online retailer (e.g., amazon.com, Walmart.com, etc.). Recipient 160 may manually enter the card number, expiration date, and security code for the VCN on the payment page of an online retailer or use digital wallet app 110 to facilitate an online or in-store purchase.

In some embodiments, a point of sale (POS) terminal for merchant 114 may send a request to backend service 102 to complete the transaction. The request may include a payment token corresponding to the VCN as well as information about the transaction. The transaction information may include information about the merchant (name, identification number (ID), address, etc.), date and time of the transaction, location of the transaction, dollar amount of the transaction, etc. Backend service 102 may use the transaction information to determine if the transaction meets the conditions for use of the VCN set by primary account holder 150. For example, primary account holder 150 may have set temporal parameters restricting when the VCN can be used. Thus, backend service 102 may use the date and time of the transaction to determine if the temporal conditions for use have been met.

In some embodiments, backend service 102 may use the location of the transaction to account for time zone differences. For example, the VCN may be intended for recipient 160 to buy lunch on weekdays and thus may have temporal parameters indicating that the VCN can only be used between 11 AM and 2 PM weekdays. Recipient 160 may be located in California while primary account holder 150 is located in Massachusetts. As such, the time zone of recipient 160 may be considered when determining whether the transaction meets the conditions for allowance.

In some embodiments, backend service 102 may use the merchant information from the request to determine the purchase category for the transaction. Backend service 102 may then compare the transaction's purchase category to the approved purchase categories for the VCN to determine whether the transaction meets the conditions for allowance. Additionally, the conditions for use of the VCN may include merchant restrictions and thus, backend service 102 may use the merchant information to determine if the transaction merchant is one of the approved merchants.

In some embodiments, backend service 102 may use the location of the transaction to determine whether the transaction meets geolocation restrictions. Additionally or alternatively, backend service 102 may ping recipient device 106 to determine the location of recipient 160. This may be particularly useful for online transactions for which the transaction location provided by merchant 114 may be the location of the merchant's headquarter as opposed to the location of recipient 160 when attempting to make the purchase.

Additionally, backend service 102 may check the current balance on the VCN to determine whether the balance will remain below the overall spending limit designated by primary account holder 150 if the transaction is completed. Backend service 102 may also determine whether the transaction is within the single-transaction spending limit.

Upon checking all the necessary parameters, backend service 102 may determine that the transaction does meet the conditions for completing a transaction with the VCN. Accordingly, backend service 102 may approve the transaction and thus allow completion of the transaction. Alternatively, backend service 102 may determine that the transaction does not meet the conditions for completing a transaction with the VCN and thus decline the transaction. In some embodiments, backend service 102 may send a message (e.g., email, SMS, push notification, etc.) to recipient 160 explaining the reason for declining the transaction. The message may additionally include a link to the VCN detail page described above. Backend service 102 may also send a message to primary account holder 150, which may include details about the attempted transaction, the reason for declining the transaction, and a link to update the VCN configurations.

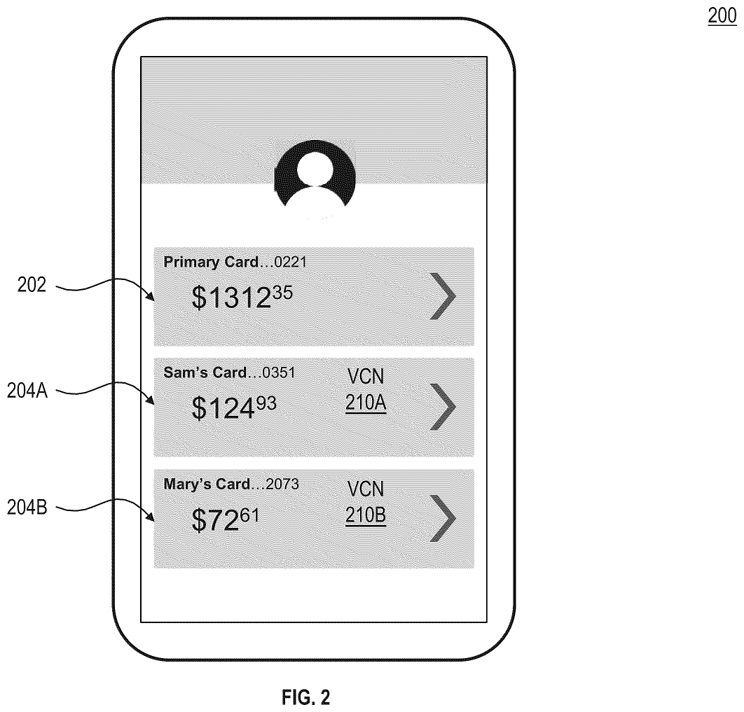

FIG. 2 illustrates an example user interface for an account overview page 200 of banking application 108A installed on account holder device 104 (of FIG. 1). Account overview page 200 may be the home screen of banking application 108A displayed when primary account holder 150 logs into the application. As shown in FIG. 2, account overview page 200 may include one or more card containers 202, 204A and 204B, wherein each card container is populated with information for a card associated with the account. Cards associated with the account may include the account holder's primary card and VCNs the account holder has created. Card container 202 may contain information for the account holder's primary card for the account, while card containers 204A and 204B may contain information for VCNs 210A and 210B, respectively, that the account holder has created and shared with a third party (e.g., a family member, friend, etc.). Each card container may comprise a nickname, last four digits of the card number, and current balance for the corresponding card. The nickname for each card may be auto-generated by backend service 102 or specified by primary account holder 150. Each card container may also include a clickable/selectable element that when selected is configured to cause a detail page for the corresponding primary card or VCN to be displayed. Alternatively, the whole container may be clickable/selectable and similarly configured to cause a VCN activity page for the corresponding card to be displayed.

The card container corresponding to the primary card 202 of primary account holder 150 may be the first card container displayed in account overview page 200. In some embodiments, the current balance displayed in primary card container 202 may be the sum of the current balance accrued on all the cards associated with the account. Alternatively, the balance displayed in primary card container 202 may only include the balance accrued on the primary card and the account balance total may be displayed separately (not shown) in account overview page 200.

VCN card containers 204A and 204B may contain information for VCNs 210A and 210B, respectively. VCN card containers 204A and 204B may be displayed in an order specified by primary account holder 150. For example, VCN card containers 204A and 204B may be displayed chronologically based on the date when the corresponding VCNs 210A and 210B were generated, alphabetically by nickname, or in ascending/descending order based on current balance or spending limit. For instance VCN card container 204A may include an element indicating a recent transaction using the corresponding VCN 210A was attempted and declined (not shown). The declined transaction indication may include a date/time for the attempted transaction. A VCN card container with a declined transaction indication may be displayed first to allow primary account holder 150 to quickly identify the VCN and take any necessary action.

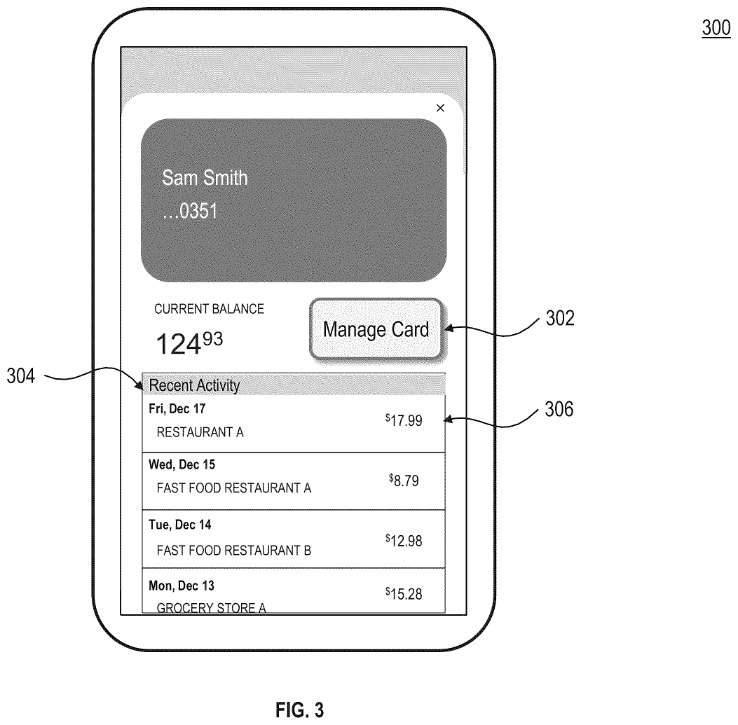

FIG. 3 illustrates an example user interface for a VCN activity page 300 of banking application 108A installed on account holder device 104 (of FIG. 1). VCN activity page 300 may be used by primary account holder 150 to review the purchase activity for time-bound VCN 210A. VCN activity page 300 may be the page displayed when VCN card container 204A is selected. As shown in FIG. 3, VCN activity page 300 may include an element at the top of the page containing text (nickname and last four digits of the card number) identifying the corresponding VCN 210A. VCN activity page 300 may also include the current balance on VCN 210A, a manage card button 302, and a list of recent activity 304.

In some embodiments, recent activity list 304 may be a list of transactions made using VCN 210A in the past seven days. Alternatively, primary account holder 150 may be able to specify a length of time (number of days, weeks, or months) for which activity for VCN 210A is displayed in recent activity list 304. For example, VCN 210A may have temporal parameters restricting its use to Wednesdays and Fridays of each week. As such, activity from the past seven days may not contain enough transactions for primary account holder 150 to get an overall understanding of how VCN 210A is being used. Accordingly, primary account holder 150 may instead want to include transactions from the past 30 days in recent activity list 304 to get a better understanding of how VCN 210A is being used. Additionally, primary account holder 150 may be able to specify a minimum and/or maximum number of transactions displayed in recent activity list 304.

Each transaction listed in recent activity list 304 may include basic information about the transaction such as a date, merchant, and dollar amount for the transaction. For example, transaction 306 was made on Friday, December 17 at Restaurant A and the total transaction amount was $17.99. Additionally, each transaction may be selected to view more information about the transaction. For example, selecting transaction 306 may cause a popup containing detailed information about the transaction to be displayed. Examples of information included in the transaction detail popup may include time of the transaction, contact information for the merchant, category of the transaction, and the purchase method (e.g., online, Apple Pay, etc.).

Primary account holder 150 may use the information about transactions made using VCN 210A found in VCN activity page 300 to determine that updating one or more of the conditions for use of VCN 210A is necessary. To make these updates, primary account holder 150 may select manage card button 302. Manage card button 302 may be configured to cause a card management page for VCN 210A to be displayed.

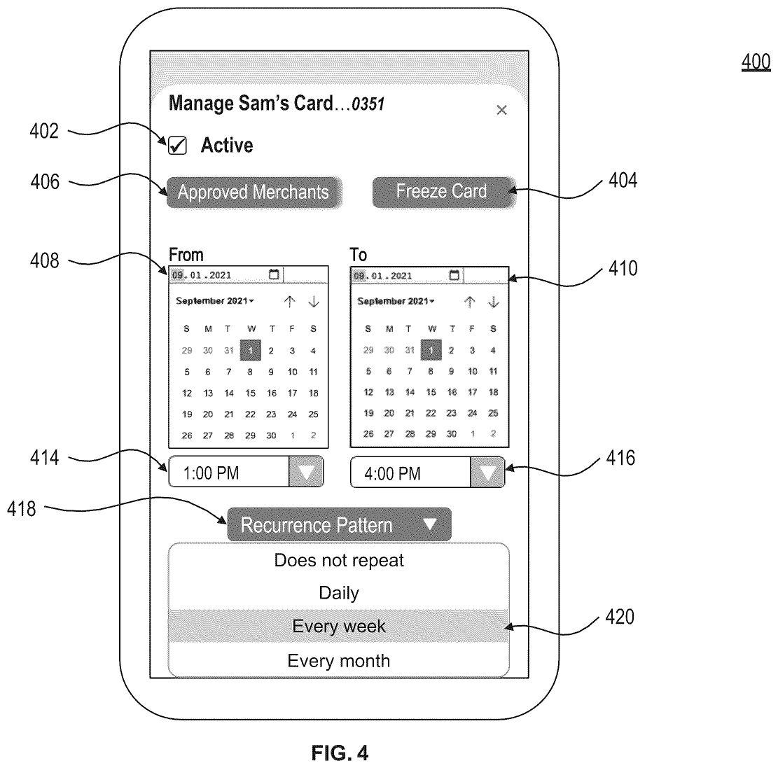

FIG. 4 illustrates an example user interface for a card management page 400 of banking application 108A installed on account holder device 104 (of FIG. 1). Card management page 400 may be used to update the conditions for use of time-bound VCN 210A. Card management page 400 may provide functionality for updating the conditions for use of VCN 210A including temporal parameters (date, time and recurrence pattern), merchant restrictions, purchase category restriction, etc.

In some embodiments, card management page 400 may have a VCN status indicator 402 which serves to identify whether the VCN is active or not. VCN status indicator 402 may indicate VCN 210A is active if VCN 210A has been received and activated by the recipient (Sam for VCN 210A). In contrast, VCN status indicator 402 may indicate VCN 210A is inactive if backend service 102 has generated VCN 210A and sent the necessary information to the recipient, but the recipient has not yet activated VCN 210A. Additionally, VCN status indicator 402 may indicate VCN 210A is inactive if the temporal parameters for VCN 210A include a recurrence pattern with an end date that has lapsed or if the temporal parameters do not include a recurrence pattern and the initial period of activity for VCN 210A has passed.

In some embodiments, card management page 400 may include a freeze card button 404. Freeze card button 404 may be used to stop any new transactions on VCN 210A from being approved regardless of whether the conditions for use have been met. This functionality is useful in the event that primary account holder 150 suspects the VCN has been compromised. Primary account holder 150 may also decide to use the freeze card functionality if they feel the VCN is being used for expenses beyond its intended use and would like to prevent any more transactions on VCN until they can update the conditions for use to better reflect the intended use.

In some embodiments, the conditions for use of VCN 210A may include merchant restrictions and thus an approved merchants button 406 may be shown on card management page 400 and configured to display a page containing a list of approved merchants upon selection. The page of approved merchants may allow primary account holder 150 to add or remove merchants from the list of approved merchants. Additionally, the page of approved merchants may include a search function allowing the account holder to quickly search for merchants by name to add to the list of approved merchants.

Alternatively, the conditions for use of VCN 210A may include purchase category restrictions and thus the approved merchant button 406 may be configured to display a page for managing the list of approved purchase categories upon selection. The approved purchase categories page may provide a list of predefined purchase categories that may be selected or deselected. Primary account holder 150 may select one or more of the purchase categories to add them to the list of approved purchase categories. Alternatively, the account holder may deselect one or more the purchase categories to remove them from the list of approved purchase categories.

In some embodiments, card management page 400 may include functionality for setting geolocation restrictions for VCN 210A. For instance, primary account holder 150 may wish to limit the use of VCN 210A based on location data such as, but not limited to, GPS data, data received from recipient device 106, a merchant address, a zip code, etc.

In some embodiments, the conditions for use of VCN 210A include temporal parameters that may be updated using card management page 400 of banking application 108A. Setting or updating the temporal parameters may include selecting an initial time period when the VCN may be used to make purchases. The initial time period may be a few hours during the day or several days depending on the intended use. For example, in FIG. 4 both the start date 408 and end date 410 are set to Sep. 1, 2021. This indicates that the initial time period will be less than 24 hours (within the day of Sep. 1, 2021). Start time 414 and end time 416 indicate the time period during this day (between 1 PM and 4 PM) when VCN 210A may be used to make purchases. As such, on Wednesday, Sep. 1, 2021.

Additionally, the temporal parameters for VCN 210A may include a recurrence pattern. For example, primary account holder 150 may select a recurrence pattern by selecting dropdown menu 418. As shown in FIG. 4, weekly recurrence pattern 420 has been selected for VCN 210A. This indicates that VCN 210A may be used to make purchases at least every Wednesday between 1 PM and 4 PM. However, primary account holder 150 may want to allow VCN 210A to be used every weekday between 1 PM and 4 PM, not just every Wednesday.

To facilitate a recurrence pattern of multiple days per week, card management page 400 may include a secondary menu (not shown) comprising a list of options based on the option selected from the first dropdown menu 418. For example, primary account holder 150 may have selected weekly recurrence option 420 from dropdown menu 418 and thus, the secondary menu may provide the following options: Mondays, Tuesdays, Wednesdays, Thursdays, Fridays, Saturdays, Sundays, Weekdays, and Weekends. Unlike the options provided in dropdown menu 418, primary account holder 150 may select one or more options from the secondary menu. For example, primary account holder 150 may want to allow VCN 210A to be used on weekdays and accordingly select the “Weekdays” option. Alternatively, if they later decide to allow purchases with VCN 210A on Mondays and Wednesdays, they may deselect “Weekdays” and instead select the options “Mondays” and “Wednesdays.” However, some options may not be able to be selected together. For example, if “Weekends” is selected, the options for “Saturdays” or “Sundays” may not be selectable until “Weekends” is deselected.

A secondary menu may also be available for monthly and yearly recurrence patterns allowing for temporal parameters that more closely reflect the intended use of the VCN.

In some embodiments, card management page 400 may also include an option to change the end date for the recurrence pattern selected from dropdown menu 418. The options for updating the end date for the recurrence pattern may be the same as those presented to primary account holder 150 when initially requesting a new VCN. Primary account holder 150 may choose to end the recurrence pattern after a certain number of occurrences and specify the number of occurrences. If this option is already selected and primary account holder 150 later changes the number of occurrences after which the recurrence pattern will terminate, the occurrence count will be reset to zero and the number of occurrences will be counted from the time of the change. Primary account holder 150 may alternatively choose to set a specific end date for the recurrence pattern or not set an end date at all and the recurrence pattern to continue indefinitely.

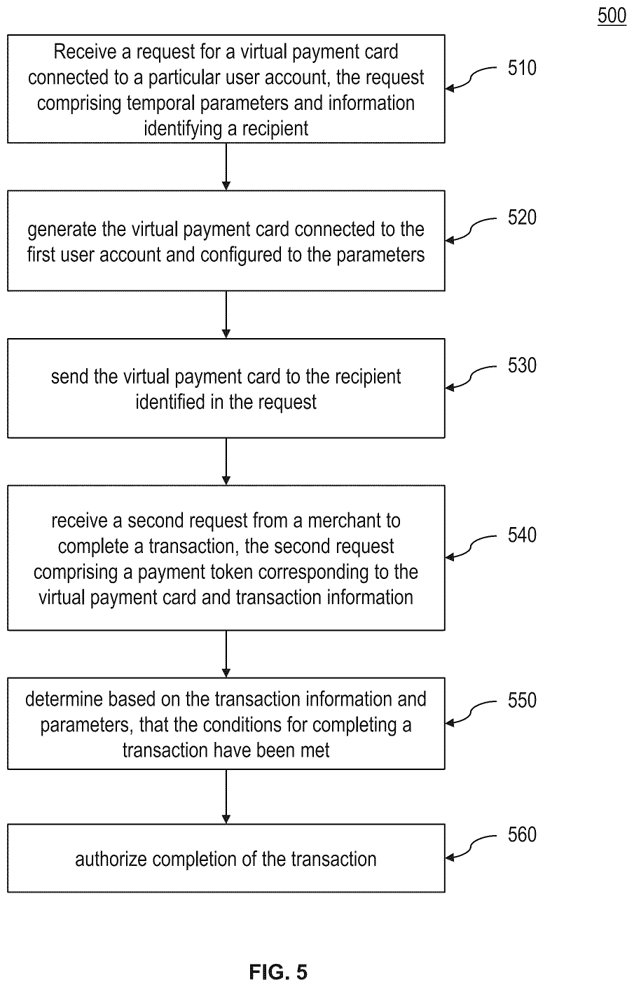

FIG. 5 illustrates a flowchart for an example method of generating and managing the use of a time-bound VCN, in accordance with some embodiments. Method 500 may be executed by one or more of the components (e.g., backend service 102, banking application 108A, banking application 108B, digital wallet app 110, etc.) discussed above in reference to FIG. 1-4. In one or more embodiments, one or more of the steps shown in FIG. 5 may be omitted, repeated, and/or performed in a different order than the order shown in FIG. 5. Accordingly, the scope of the invention should not be considered limited to the specific arrangement of steps shown in FIG. 5. The steps shown in FIG. 5 may be implemented as computer-readable instructions stored on computer-readable media, where, when the instructions are executed, cause a processor to perform the process of FIG. 5. Method 500 shall be described with reference to FIG. 1. However, method 500 is not limited to those example embodiments.

In 510, backend service 102 receives a first request from banking application 108A to generate a new VCN linked to a particular user account (primary account). The particular user account may be that of primary account holder 150. The first request may comprise parameters describing conditions for completing a transaction with the VCN and information identifying a recipient to whom the VCN will be issued. The parameters may be specified by primary account holder 150 as described above in reference to FIG. 1. By way of a non-limiting example, the parameters describing conditions for completing a transaction with the VCN may include but are not limited to temporal parameters, merchant restrictions, purchase category restrictions, geolocation restrictions, a per-transaction spending limit, an overall spending limit, etc. The temporal parameters may include a recurring time period when the VCN may be used to make purchases, a recurrence pattern, and an end date for the recurrence pattern.

The recipient information in the first request may identify recipient 160. In some embodiments, backend service 102 may verify the information identifying recipient 160. Backend service 102 may also determine whether an account exists for recipient 160. If no account exists for recipient 160, backend service 102 may create an authorized user account for recipient 160. In some embodiments, the authorized user account for recipient 160 may be linked to the primary account but may provide limited functionality. Alternatively, if recipient 160 has an existing account, backend service 102 may use the recipient information from the first request (e.g., email address, phone number, etc.) to match recipient 160 with an existing account.

In 520, backend service 102 generates a new VCN linked to the account of primary account holder 150 and configured to the parameters specified in the first request. Generating a new VCN may include generating a unique card number different from the card number associated with the primary account. Additionally, backend service 102 may link the new VCN to the authorized user account for recipient 160.

In 530, backend service 102 sends the VCN to recipient 160. In some embodiments, backend service 102 may send a message (e.g., email, SMS, etc.) to recipient 160 indicating that a VCN has been sent to recipient 160 by primary account holder 150 and containing information regarding activation and use of the VCN. Additionally, if a new authorized user account was created for recipient 160, the message may also provide information regarding the new authorized user account created for the recipient and a link to activate the authorized user account. However, if an existing account was identified for recipient 160, the message may instead contain a link to activate VCN.

In some embodiments, if backend service 102 has identified an existing account for recipient 106, backend service 102 may use the account to determine that recipient 160 has banking application 108B installed on their device 106 and send a push notification to recipient device 106. The notification may notify recipient 160 that they have received a new VCN and prompt them to activate the VCN. Selecting the notification may cause recipient device 106 to launch banking application 108B. In some embodiments, banking application 108B may be configured to prompt recipient 160 to authenticate using account credentials (username and password), biometrics, or another authentication method before gaining access to their account. Upon successful authentication, banking application 108B may present recipient 160 a VCN activation screen.

In 540, backend service 102 receives a second request from a POS terminal for merchant 114 to complete a transaction. The second request may comprise a payment token corresponding to the VCN and information about the transaction. The transaction information may include information about the merchant (name, identification number (ID), address, etc.), date and time of the transaction, location of the transaction, dollar amount of the transaction, etc. Backend service 102 may use the transaction information to determine if the transaction meets the conditions for use of the VCN set by primary account holder 150.

In 550, backend service 102 determines, based on the transaction information and the conditions for completing a transaction with the VCN, that the conditions for completing a transaction have been met. For example, backend service 102 may use the date and time of the transaction to determine that the temporal conditions have been met. Additionally, backend service 102 may use the merchant ID of merchant 114 to determine whether merchant 114 is an approved merchant. Alternatively, backend service 102 may use the merchant ID of merchant 114 to determine the purchase category of the transaction and further determine whether it falls under an approved purchase category. Backend service 102 may also check whether the transaction is within the per-transaction spending limit and keeps the overall account balance under the over spending limit set for the VCN.

In 560, backend service 102 authorizes completion of the transaction and sends an indication to the POS terminal for merchant 114 that the transaction has been approved. Accordingly, the transaction may be completed. In some embodiments, backend service 102 may send primary account holder 150 a message or notification indicating a transaction has been made with the VCN. Primary account holder 150 may opt in to receiving notifications regarding approved transactions. Alternatively, primary account holder 150 may opt out from receiving such notifications.

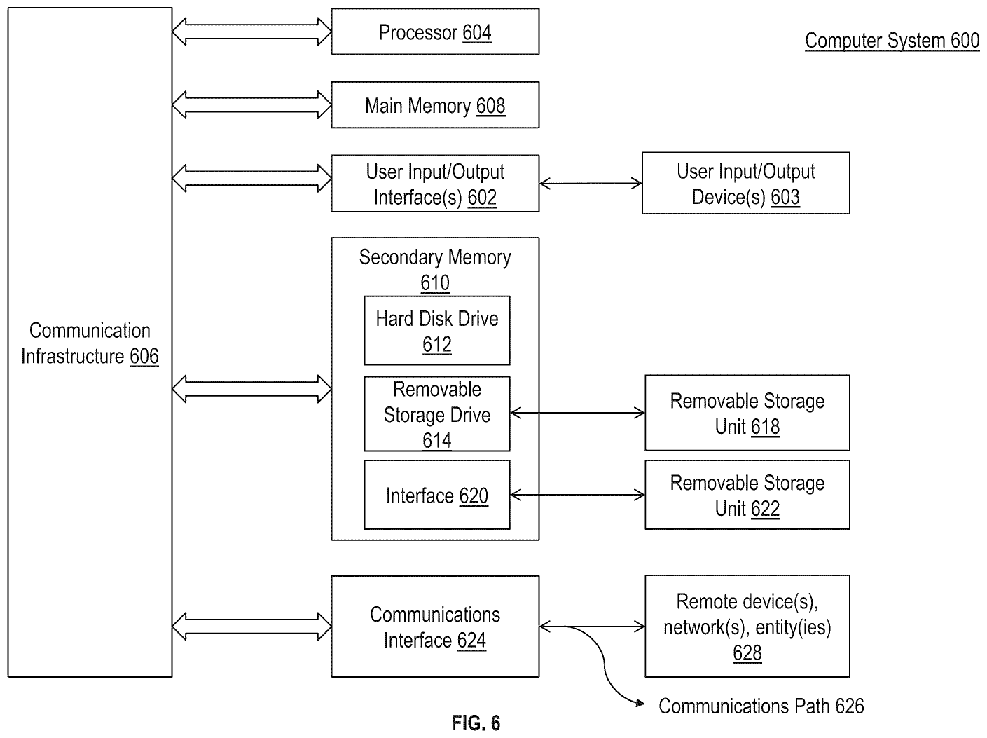

Various embodiments may be implemented, for example, using one or more well-known computer systems, such as a computer system 600, as shown in FIG. 6. One or more computer systems 600 may be used, for example, to implement any of the embodiments discussed herein, as well as combinations and sub-combinations thereof. The computer systems 600 may be used for the implementation of one or more embodiments described above.

The computer system 600 may include one or more processors (also called central processing units, or CPUs), such as a processor 604. The processor 604 may be connected to a communication infrastructure or bus 606.

The computer system 600 may also include user input/output device(s) 603, such as monitors, keyboards, pointing devices, etc., which may communicate with communication infrastructure 606 through user input/output interface(s) 602.

One or more processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 600 may also include a main or primary memory 608, such as random access memory (RAM). Main memory 608 may include one or more levels of cache. Main memory 608 may have stored therein control logic (i.e., computer software) and/or data.

The computer system 600 may also include one or more secondary storage devices or memory 610. The secondary memory 610 may include, for example, a hard disk drive 612 and/or a removable storage device or drive 614. The removable storage drive 614 may be a floppy disk drive, a magnetic tape drive, a compact disk drive, an optical storage device, tape backup device, and/or any other storage device or storage drive.

The removable storage drive 614 may interact with a removable storage unit 618. The removable storage unit 618 may include a computer-usable or readable storage device having stored thereon computer software (control logic) and/or data. The removable storage unit 618 may be a floppy disk, magnetic tape, compact disk, DVD, optical storage disk, and/or any other computer data storage device. The removable storage drive 614 may read from and/or write to the removable storage unit 618.

The secondary memory 610 may include other means, devices, components, instrumentalities, or other approaches for allowing computer programs and/or other instructions and/or data to be accessed by the computer system 600. Such means, devices, components, instrumentalities, or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 600 may further include a communication or network interface 624. The communication interface 624 may enable the computer system 600 to communicate and interact with any combination of external devices, external networks, external entities, etc. (individually and collectively referenced by reference number 628). For example, the communication interface 624 may allow the computer system 600 to communicate with the external or remote devices 628 over communications path 626, which may be wired and/or wireless (or a combination thereof), and which may include any combination of LANs, WANs, the Internet, etc. Control logic and/or data may be transmitted to and from the computer system 600 via the communication path 626.

The computer system 600 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

The computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computer system 600, the main memory 608, the secondary memory 610, and the removable storage units 618 and 622, as well as tangible articles of manufacture embodying any combination of the foregoing. Such control logic, when executed by one or more data processing devices (such as the computer system 600), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 6. In particular, embodiments can operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

1. A computer-implemented method, comprising:
receiving, by one or more computing devices, a first request, from a first user, for a virtual payment card connected to a first user account, the first request comprising:
parameters describing conditions for completing a transaction with the virtual payment card, wherein the parameters comprise recurring temporal parameters, a recurrence pattern, and an end date for the recurrence pattern; and
information identifying a recipient;
generating, by the one or more computing devices, the virtual payment card connected to the first user account and configured to the parameters;
creating, by the one or more computing devices, a second user account for the recipient, wherein the second user account is connected to the first user account and wherein the second account is accessible to the recipient via a banking platform;
sending, by the one or more computing devices, the virtual payment card to the recipient identified in the first request;
receiving, by the one or more computing devices, a second request, from a point of sale terminal of a merchant, to complete a transaction, wherein the second request comprises a payment token corresponding to the virtual payment card and transaction data indicating at least:
a transaction time;
the merchant; and
a transaction location;
determining, by the one or more computing devices, based on the transaction data and parameters, that the conditions for completing a transaction have been met;
authorizing, by the one or more computing devices, completion of the transaction; and
updating, by the one or more computing devices, the second user account with the completed transaction, wherein the first user account is configured to allow the first user to view updates to the second account.

2. The method of claim 1, wherein a primary payment card with a unique first primary account number (PAN) is associated with the first user account, and wherein the virtual payment card has a second PAN different from that of the primary payment card.

3. The method of claim 1, wherein the parameters describing conditions for completing a transaction with the virtual payment card further comprise one or more merchants and one or more geolocations.

4. The method of claim 1, further comprising:
sending, by the one or more computing devices, an invitation to the recipient to activate the second user account.

5. The method of claim 4, wherein the second user account allows the recipient to view account information pertaining to the virtual payment card,
wherein the account information pertaining to the virtual payment card comprises:
a current balance;
the parameters describing conditions for completing a transaction with the virtual payment card; and
a list of transactions made using the virtual card.

6. The method of claim 1, further comprising:
receiving, by the one or more computing devices, a third request, from a third-party digital wallet associated with the recipient, to allow the third-party digital wallet to enroll the virtual payment card, wherein the third request comprises an authentication token that identifies the recipient;
authenticating, by the one or more computing devices, the recipient and third-party digital wallet;
authorizing, by the one or more computing devices, enrollment of the virtual payment card with the third-party digital wallet, such that transactions can be made using the virtual payment card from the third-party digital wallet.

7. The method of claim 1, further comprising:
receiving, by the one or more computing devices, a fourth request, from the first user, to update the parameters describing conditions for completing a transaction with the virtual payment card, the fourth request comprising updated parameters;
configuring, by the one or more computing devices, the virtual payment card with parameters; and
sending, by the one or more computing devices, the virtual payment card, configured with the updated parameters, to the recipient.

8. A system, comprising:
a memory; and
at least one processor coupled to the memory and configured to:
receive a first request, from a first user, for a virtual payment card connected to a first user account, the first request comprising:
parameters describing conditions for completing a transaction with the virtual payment card, wherein the parameters comprise recurring temporal parameters, a recurrence pattern, and an end date for the recurrence pattern; and
information identifying a recipient;
generate the virtual payment card connected to the first user account and configured to the parameters;
create a second user account for the recipient, wherein the second user account is connected to the first user account and wherein the second account is accessible to the recipient via a banking platform;
send the virtual payment card to the recipient identified in the first request;
receive a second request, from a point of sale terminal of a merchant, to complete a transaction, wherein the second request comprises a payment token corresponding to the virtual payment card and transaction data indicating at least:
a transaction time;
the merchant; and
a transaction location;
determine based on the transaction data and parameters, that the conditions for completing a transaction have been met;
authorize completion of the transaction; and
update the second user account with the completed transaction, wherein the first user account is configured to allow the first user to view updates to the second account.

9. The system of claim 8, wherein a primary payment card with a unique first primary account number (PAN) is associated with the first user account, and wherein the virtual payment card has a second PAN different from that of the primary payment card.

10. The system of claim 8, wherein the parameters describing conditions for completing a transaction with the virtual payment card further comprise one or more merchants and one or more geolocations.

11. The system of claim 8, wherein the at least one processor is further configured to:
send an invitation to the recipient to activate the second user account.

12. The system of claim 11, wherein the second user account allows the recipient to view account information pertaining to the virtual payment card, and
wherein the account information pertaining to the virtual payment card comprises:
a current balance;
the parameters describing conditions for completing a transaction with the virtual payment card; and
a list of transactions made using the virtual card.

13. The system of claim 8, wherein the at least one processor is further configured to:
receive a third request, from a third-party digital wallet associated with the recipient, to allow the third-party digital wallet to enroll the virtual payment card, wherein the third request comprises an authentication token that identifies the recipient;
authenticate the recipient and third-party digital wallet;
authorize enrollment of the virtual payment card with the third-party digital wallet, such that transactions can be made using the virtual payment card from the third-party digital wallet.

14. The system of claim 8, wherein the at least one processor is further configured to:
receive a fourth request, from the first user, to update the parameters describing conditions for completing a transaction with the virtual payment card, the fourth request comprising updated parameters;
configure the virtual payment card with parameters; and
send the virtual payment card, configured with the updated parameters, to the recipient.

15. A non-transitory computer-readable device having instructions stored thereon that, when executed by at least one computing device, cause the at least one computing device to perform operations comprising:
receiving a first request, from a first user, for a virtual payment card connected to a first user account, the first request comprising:
parameters describing conditions for completing a transaction with the virtual payment card, wherein the parameters comprise recurring temporal parameters, a recurrence pattern, and an end date for the recurrence pattern; and
information identifying a recipient;
generating the virtual payment card connected to the first user account and configured to the parameters;
creating a second user account for the recipient, wherein the second user account is connected to the first user account and wherein the second is accessible to the recipient via a banking platform;
sending the virtual payment card to the recipient identified in the first request;
receiving a second request, from a point of sale terminal of a merchant, to complete a transaction, wherein the second request comprises a payment token corresponding to the virtual payment card and transaction data indicating at least:
a transaction time;
the merchant; and
a transaction location;
determining based on the transaction data and parameters, that the conditions for completing a transaction have been met;
authorizing completion of the transaction; and
updating the second user account with the completed transaction, wherein the first user account is configured to allow the first user to view updates to the second account.

16. The non-transitory computer-readable device of claim 15, wherein a primary payment card with a unique first primary account number (PAN) is associated with the first user account, and wherein the virtual payment card has a second PAN different from that of the primary payment card.

17. The non-transitory computer-readable device of claim 15, the operations further comprising:
sending an invitation to the recipient to activate the second user account.

18. The non-transitory computer-readable device of claim 18, wherein the second user account allows the recipient to view account information pertaining to the virtual payment card,
wherein the account information pertaining to the virtual payment card comprises:
a current balance;
the parameters describing conditions for completing a transaction with the virtual payment card; and
a list of transactions made using the virtual card.

19. The non-transitory computer-readable device of claim 15, the operations further comprising:
receiving a third request, from a third-party digital wallet associated with the recipient, to allow the third-party digital wallet to enroll the virtual payment card, wherein the third request comprises an authentication token that identifies the recipient;
authenticating the recipient and third-party digital wallet;
authorizing enrollment of the virtual payment card with the third-party digital wallet, such that transactions can be made using the virtual payment card from the third-party digital wallet.

20. The non-transitory computer-readable device of claim 15, the operations further comprising:
receiving a fourth request, from the first user, to update the parameters describing conditions for completing a transaction with the virtual payment card, the fourth request comprising updated parameters;
configuring the virtual payment card with parameters; and
sending the virtual payment card, configured with the updated parameters, to the recipient.
